(19) United States
(12) Patent Application Publication
(10) Pub. No.: US 2013/0196586 A1
(43) Pub. Date: Aug. 1, 2013

(54) WINDSHIELD DEFROST/DEMIST FLOW SUCTION CONTROL

(71) Applicants: Paul Bryan Hoke, Plymouth, MI (US); Mark M. Doroudian, Novi, MI (US); Clay Wesley Maranville, Ypsilanti, MI (US); David H. Ervin, Whitmore Lake, MI (US)

(72) Inventors: Paul Bryan Hoke, Plymouth, MI (US); Mark M. Doroudian, Novi, MI (US); Clay Wesley Maranville, Ypsilanti, MI (US); David H. Ervin, Whitmore Lake, MI (US)

(73) Assignee: FORD GLOBAL TECHNOLOGIES, LLC, DEARBORN, MI (US)

(21) Appl. No.: 13/361,983

(22) Filed: Jan. 31, 2012

(51) Int. Cl. B60H 1/24

(52) U.S. Cl. 454/127

(57) ABSTRACT

A vehicle's front windshield's defrost airflow control system regulates the pattern of defrost airflow over the front windshield, and partially directs the defrost air towards rear portions of the vehicle. A number of suction ports provided over the front windshield's periphery, suck the defrost air discharged over the front windshield. A conduit communicates directs the sucked defrost air over the top of the front side glass, the rear side glass, and the rear windshield of the vehicle. A suction blower positioned within the conduit, enables suction of the defrost air through the suction ports, and guides the sucked air through a number of discharge ports mounted over the front side glass, the rear side glass and the rear windshield. The system enables defrost effect over the side glass and the rear windshield of the vehicle, and prevents penetration of defrost air into the eyes of the front occupant.

### BACKGROUND

Defrosters/demisters are used to thaw ice accumulated over the front windshield and the side glasses/rear windshield of vehicles. Vehicle defrosters often use defrost nozzles that eject hot and dehumidified air over the windshield, which melts the condensed frost and evaporates the fog from the windshield. The performance of defrost systems depends upon a number a factors, including the distribution of the defrost air-flow over the windshield, the discharge temperature of the defrost air and its absolute humidity. The design of the defrost nozzle for the front windshield is constrained by a couple of factors, including the amount of available space and other design/packaging criteria. At times, styling and package constraints limit the width of the defrost nozzle, and the flow of the discharged defrost air to the corners of the windshield becomes difficult. In cases where devices including the sun-load sensors, auto-lamp sensors or heads up displays (HUD) are packaged in the instrumental panel of the vehicle, the demisting of some areas of the front windshield, specifically near the center top, becomes even more difficult. Further, defrost air rising along the front windshield, often reflects from the glass and enters into the eyes of the front occupants. Since the defrost air has high water absorption capabilities, its exposure to the eyes of vehicle occupants may cause the dry-eyes.

Considering the aforementioned problems, there exists a need for a better defrost flow control system that will regulate defrost airflow pattern over the front windshield, as well as aid in actively defrosting the side glass and the rear windshield.

### SUMMARY

The present disclosure describes a system for controlling the flow of defrost air over the front windshield, to allow the defrost air to reach inaccessible portions of the front windshield, and to direct the defrost air backwards along the rear windshield and the side glass.

The system includes multiple suction ports provided over the periphery of the front windshield of the vehicle. One or more suction blowers fluidly communicate with the suctions ports, and suck the air discharged from the front windshield's defrost nozzle, through the suction ports. The suction blowers are mounted close to the top part of the A-pillar or the B-pillar, and they suck defrost air discharged by the defrost nozzle, through the suction ports. The suction blowers are connected to a conduit to route the sucked air backwards and sideways. The conduit divides into a number of channels that terminate into discharge ports, to discharge the sucked air. The discharge ports are mounted over the driver side glass, the side occupant glass and/or the rear windshield, and they discharge the sucked air over them, to aid in defrosting the windshields and side glass. Optionally, a heating device is positioned within the conduit to further increase the temperature of the sucked air, before it is discharged over the side glass and the rear windshield. In one aspect, at least one suction port is provided in the space between the front windshield's headliner and the roof of the vehicle, to enable suction of the defrost air through the top-center of the front windshield. In another aspect, at least two suction ports are provided near the bottom ends of the two A-pillars of the vehicle, to enable suction of the defrost air from the bottom corners of the front windshield. Similarly, two suction ports are optionally provided over the top portions of the two A-pillars of the vehicle, to enable suction of the air through the top corners of the front windshield.

The system substantially alleviates the problem of dry defrost air entering into the eyes of the front occupants. Further, it enables easy and effective demisting of the side glass and/or the rear windshield during winter seasons.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

FIG. 1 shows a side view of the vehicle, with the defrost airflow control system provided thereon, in accordance with the present disclosure.

FIG. 2 is a top view of a first embodiment for implementing the defrost airflow control system, showing the position of the suction blower and the suction ports, in accordance with the present disclosure.

FIG. 3 is a side perspective view of a second embodiment for enabling the defrost airflow control system, in accordance with the present disclosure.

FIG. 4 is a top view of a third embodiment for enabling the defrost airflow control system, in accordance with the present disclosure.

FIG. 5 is a side perspective view of a fourth embodiment for enabling the defrost airflow control system, in accordance with the present disclosure.

### DETAILED DESCRIPTION OF ILLUSTRATIVE EMBODIMENTS

The following detailed description illustrates aspects of the disclosure and the ways it can be implemented. However, the description does not define or limit the invention, such definition or limitation being solely contained in the claims appended thereto. Although the best mode of carrying out the invention has been disclosed, those in the art would recognize that other embodiments for carrying out or practicing the invention are also possible.

The present disclosure pertains to a system for controlling the pattern of defrost air-flow over the front windshield of a vehicle, and for directing the front windshield defrost air towards other portions of the vehicle, specifically over the driver side-glass, the side occupant glass and the rear windshield. The system enables easy demisting of some conventionally inaccessible portions of the front windshield of a vehicle, and helps prevent dry defrost air from directly entering the eyes of the front occupants.

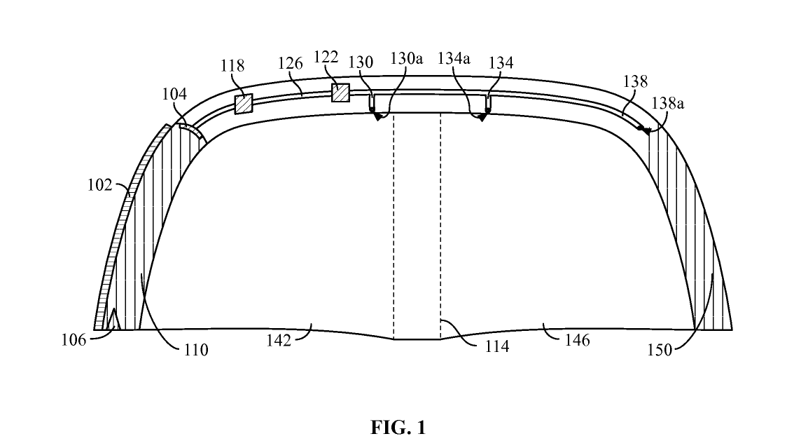

FIG. 1 is a side view of the vehicle, with a suction blower positioned close to the front windshield, and a conduit for discharging the sucked defrost air backwards and towards the front and the rear side glass of the vehicle. As shown, a defrost nozzle 106 (herein after referred to as ‘nozzle 106’, for simplicity of expression) is disposed at the bottom portion of the front windshield 102. The system for defrost airflow control, in accordance with the present disclosure, is compatible with and works well with any position of the nozzle 106 over the front windshield 102, and hence, the illustrated position of the nozzle 106 does not limit the scope of the disclosure. The nozzle 106 discharges air towards the top and sideways over an inner portion of the windshield 102. A suction port 104 is provided, at an appropriate location over the top peripheral surface of the windshield 102, either at the center or over a corner. A number of similar suction ports are provided at different locations over the peripheral surface of the windshield 102, as will be explained in further details hereinafter, in conjunction with subsequent figures of the disclosure. A suction blower 118 communicates with the suction port 104, sucks the defrost air, accelerates it and guides it towards a conduit 126. The conduit extends between the exterior of the vehicle and the vehicle interior lining, and is constructed in a conventional fashion for channeling air. For example, the conduit can be made of a stiff fabric or plastic. Those in the art will understand that the suction blower 118 uses centrifugal force generated by a set of fan blades to suck and guide the defrost air along the conduit 126. Further, the suction blower 118 can also use an axial fan for sucking and guiding the defrost air, thus not limiting the scope of the disclosure. The conduit 126 is positioned substantially along the top portions of the driver side glass 142 and the rear side glass 146, thus extending all the way from the A-pillar 110 through the B-pillar 114, and further beyond, towards the rear windshield 150. The conduit 126 is designed to take into account changes in the pressure and temperature of the defrost air flowing through it. In one aspect, to incorporate any decrease in the temperature of defrost air during its transmission, a heating device 122 is positioned with the conduit 126 to increase the temperature of the defrost air. Any appropriate device known in the art, and suitable for the mentioned purpose, can be used as the heating device.

As shown, the conduit 126 divides into a number of channels 130, 134 and 138. The channel 130 culminates into a discharge port 130 (a), which discharges the sucked defrost air over the driver side glass 142. A similar arrangement along the other side of the vehicle is configured to discharge defrost air partially over the side occupant glass, to enable demisting thereon. Similarly, channels 134 and 138 culminate into discharge ports 134 (a) and 138 (a) respectively. The discharge ports 134 (a) and 138 (a) enable the discharge of defrost air over the rear side glass 146 and the rear windshield 150, respectively.

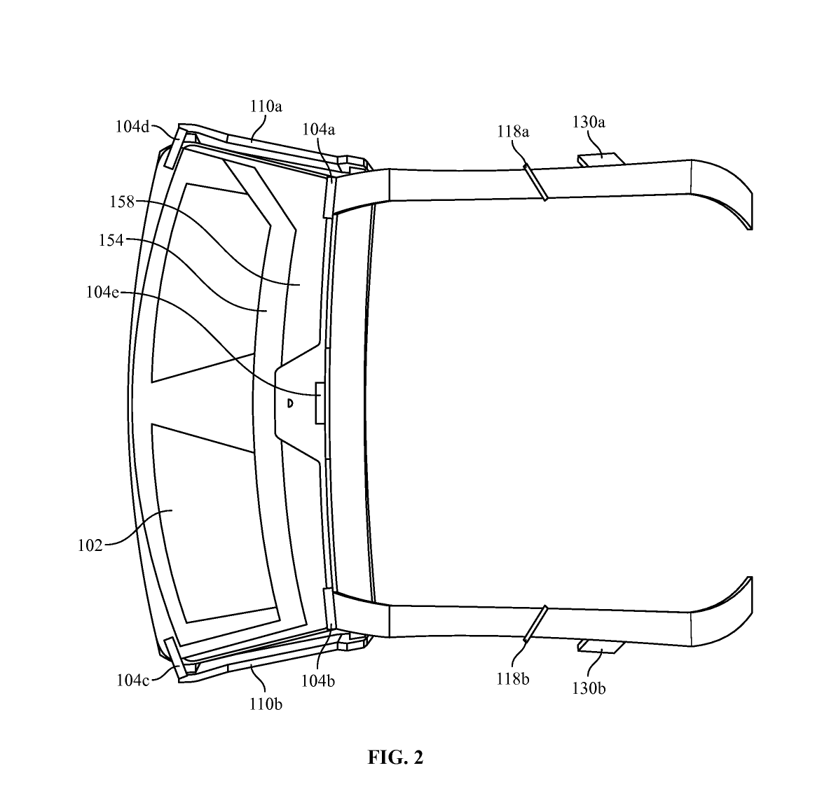

Different positions of the suction ports 104 over the front windshield 102 of the vehicle, have been tried and analyzed through computational fluid dynamics, and the velocity profile of the defrost air over the windshield 102 has been studied to simulate the best performance of the defrost air-flow pattern control over the front windshield 102. FIGS. 2 through 5 illustrate different embodiments of the system of the present disclosure, wherein the multiple suction ports 104 are mounted at different locations over the front windshield 102, and the amount of defrost air sucked through the different suction ports 104 is varied to obtain the best results.

FIG. 2 shows a first embodiment of the present disclosure, wherein two suction ports 104 (a) and 104 (b) are positioned over a top portion of the front windshield 102, substantially proximal to the corners, and in the space between the headliner 154 and the roof surface 158. Further, two more suction ports 104 (c) and 104 (d), are positioned close to the bottom portions of the two A-pillars 110 (a) and 110 (b), over the bottom peripheral surface of the windshield 102. Another suction port 104 (e) is provided at the center of the top peripheral surface of the windshield 102. As shown, the suction ports are of rectangular cross-section. However, those in the art will understand that suction ports of any other suitable cross-section may be used. This may include suction ports with circular, ovular or elliptical cross-section, thus not limiting the scope of the disclosure. The suction ports disposed over the corners, i.e., 104 (a), 104 (b), 104 (c) and 104 (d) are adapted to suck about 10 cubic feet per minute (CFM) of defrost air discharged over the front windshield 102, by the defrost nozzle (not shown). The suction port 104 (e) at the top center, sucks about 30 CFM of defrost air for optimum performance. These specific defined values of the flow rates at which the defrost air is sucked through different suction ports, correspond to one of the multiple possible embodiments, set for different case studies. However, those in the art would understand that the suction flow rates through different ports can be varied to obtain different results simulating optimum performance. The suction flow rates through different suction ports actually depends upon certain parameters including, though not be limited to, the vehicle's defrost system and the objectives associated therewith. The suction flow rate values can be tuned to obtain desired vehicle performance, and can further be customized for a trade-off with other vehicle attributes, including the vehicle's NVH system characteristics. Two blowers, 118 (a) and 118 (b), as shown, are provided over the top portions of the side glass, one on each side of the vehicle. Two discharge ports, 130 (a) and 130 (b), discharge the defrost air sucked by the blowers 118 (a) and 118 (b), respectively, partially over the front side glass, and partially over the rear side glass of the vehicle. Though not shown in the figure, similar suction ports can be mounted over the peripheral surface of the rear windshield, to enable demisting thereon. As observed through analysis of the defrost airflow pattern, and specifically by obtaining results from the case study on this exemplary embodiment, most of the frost accumulated over the front windshield 102 thaws in about 15 minutes. Further, in about 25 minutes, most of the defrosting is effectively accomplished, with only few bits of ice left around the top left and the top right corners.

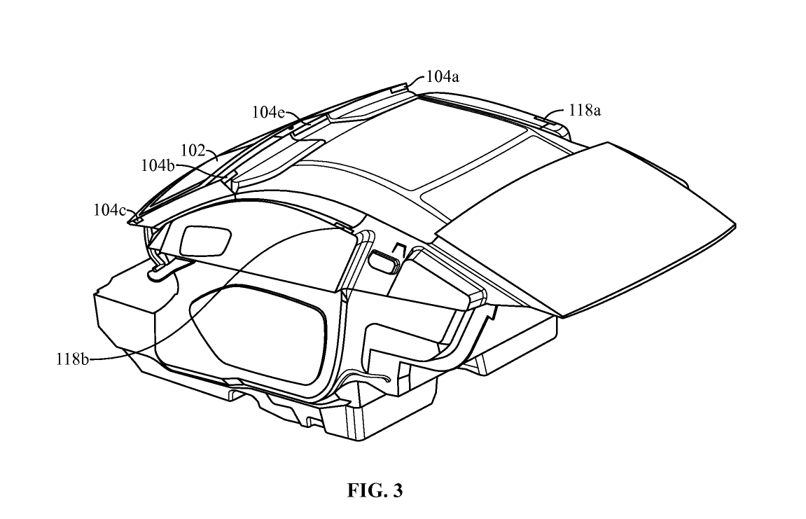

FIG. 3 shows a second embodiment, wherein the suction ports 104 (a) and 104 (b) at the top corners, and the suction port 104 (e) at the top center of the windshield 102, have more suction area than the suction ports 104 (c) and 104 (d) at the bottom corners. Specifically, the suction ports at the top corners and the top center have a rectangular cross-section with approximate dimensions of about 100×20 mm², and each one of them is adapted to suck about 10 CFM of defrost air from the front windshield. The suction ports 104 (c) and 104 (d) at the bottom corners have dimensions that are approximately about 50×20 mm². The size and dimensions of the different suction ports can be varied and tuned for the desired flow characteristics and the blower fan capabilities, thus not limiting the scope of the disclosure. Specifically, three suction ports 104 (e), though not explicitly shown, are provided at the top center in this embodiment, to suck more volume of defrost air from the central portion of the windshield 102. These ports suck about 10 CFM of defrost air each, from areas close to the top center of the windshield 102. As observed through analysis, it is found that most of the defrosting is effectively complete in about 25 minutes, and small pieces of frost remain unthawed near the top left and the top right portions of the windshield 102. Further, airflow velocity is found to be substantially uniform all over the entire surface windshield 102 within 20 minutes of operation, specifically in the range of about 0.4 to 1.0 m/s.

In another aspect, about 15 CFM of suction is enabled through each of the suction ports shown in FIG. 3. Altogether, more than about 100 CFM of defrost air is sucked through the entire windshield surface (through three suction ports at the centre and two each at the top and bottom corners), thus achieving substantial defrost effect in about 20-25 minutes of operation. A uniform defrost airflow velocity in the range of about 0.4-1.0 m/s is achieved in about 20 minutes of operation, with this volume of defrost air sucked through the suction ports. Effectively, the time taken to obtain a substantial defrost effect on front windshield, the rear windshield and/or the side glasses, depends upon parameters including the vehicle's engine performance and the overall system design characteristics. Those in the art would understand that the aforementioned times correspond to specific case studies, and the exact time consumed in demisting of different glasses can vary based on such parameters.

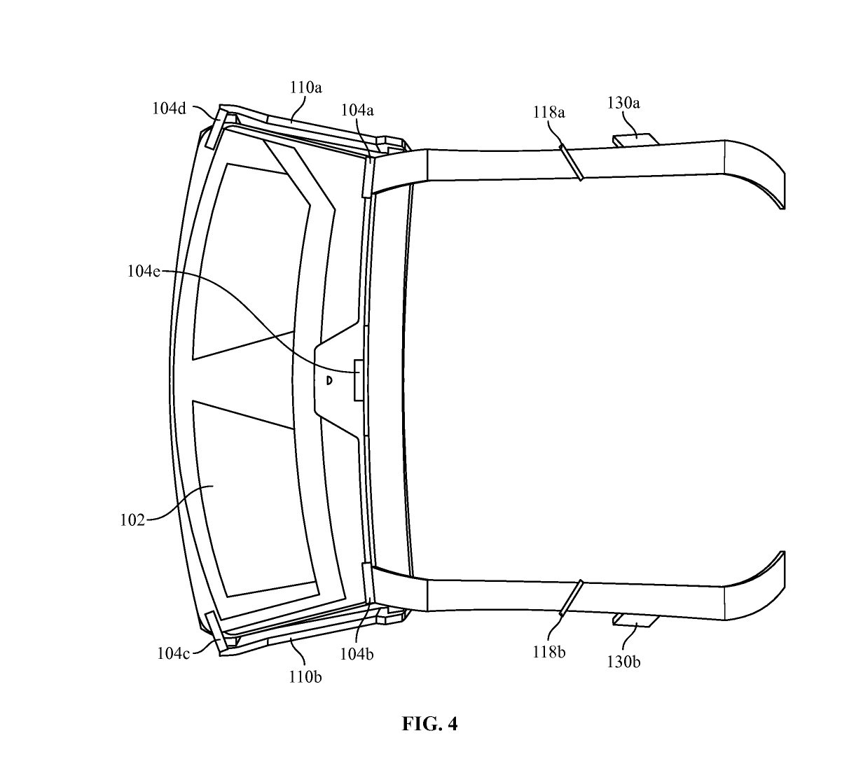

FIG. 4 shows another embodiment wherein the suction port 104 (e) is adapted to suck about 45 CFM of defrost air through the top central portion of the windshield 102. The suction ports at the top and bottom corners of the windshield 102, i.e., 104 (a), 104 (b), 104 (c) and 104 (d), suck about 15 CFM of defrost air each from the corners of the windshield 102. Small bits of frost remain unthawed in about 30 minutes of operation, in this embodiment. Further, velocity contour profiles show that high velocity flows are confined substantially within the bottom portion of the windshield 102, and defrost air velocity around the top let and top right corners of windshield 102 is found to be minimum. Analysis of melting patterns for ice reveals that the melting pattern proliferates, starting from the bottom portion of windshield 102, and eventually ice at the top portions of the windshield thaws in about 15-20 minutes.

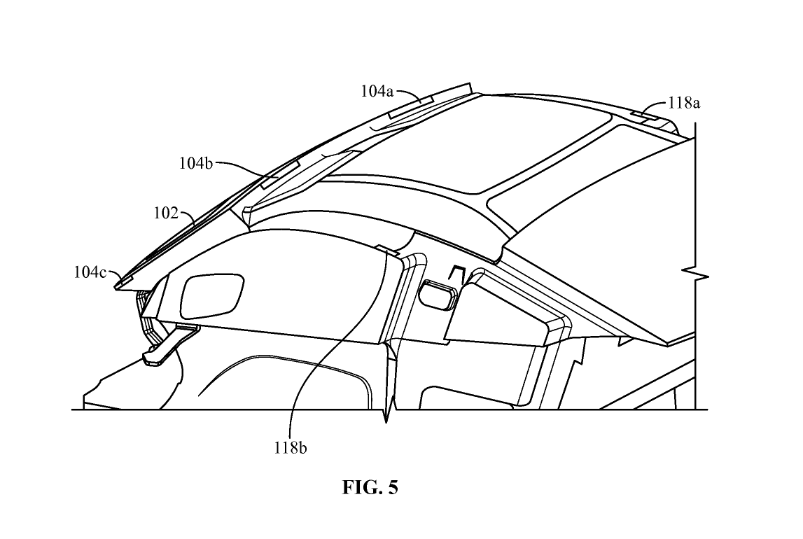

In another embodiment, as shown in FIG. 5, suctions ports are provided only along the tops corners and the bottom corners of the windshield 102. The suction ports 104 (a) and 104 (b) at the top corners, and the suction ports 104 (c) and 104 (d) at the bottom corners of the windshield 102, are of about 200×20 mm² cross-sectional area, and are each adapted to suck about 10 CFM of defrost air from the windshield's surface. In about 25-30 minutes of operation, ice thaws substantially, and the front windshield 102 is effectively demisted, with no bits of ice remaining unthawed anywhere over its surface. The melting pattern is similar to that in previous embodiments, and the melting region develops eventually, starting from the bottom and expanding substantially towards the top center and further towards the top corners.

The front windshield defrost airflow pattern controlling system of the present disclosure can also be used to evacuate the vehicle's interior. In such an implementation, the suction blowers are configured to suck the air within the vehicle's interior and eject it towards the exterior of the vehicle. The discharge ports are mounted at appropriate locations to discharge the sucked air outwards.

The disclosed system for controlling the defrost air-flow pattern over a vehicle's front windshield, and directing the flow of defrost air towards rear portions of the vehicle, is suitable for use in any vehicle provided with any of the conventional defrost mechanisms for the front windshield, and is compatible with any position of the defrost nozzle over the front windshield. Further, the cross-section area of the suction ports, and the volume of defrost air sucked through them, can be varied, to achieve different flow profiles for the defrost air over the front windshield, thus not limiting the scope of the present disclosure. Additionally, there is no constraint on the number and positioning of the suction blowers, to enable the disclosure, and different embodiments may include use of different number of suction blowers, mounted at different locations within the vehicle, to achieve different defrost airflow profiles.

As aforementioned, the direction of defrost air towards the rear portion of the vehicle, and specifically over the side glass and the rear windshield, substantially reduces the amount of defrost air entering directly into the eyes of the front occupants, provides more comfort to the eyes of the front occupants while driving, and further mitigates the ‘dry eye’ threats to the occupants over a longer run. Additionally, effective defrosting is achieved over the entire surface of the front windshield, specifically over the inaccessible areas like the windshield's corners. Further, defrosting of the side glass and the rear windshield is effectively achieved.

Although the current invention has been described comprehensively, in considerable details to cover the possible aspects and embodiments, those skilled in the art would recognize that other versions of the invention are also possible.

What is claimed is:

1. A system for controlling defrost airflow patterns over the front windshield, and directing defrost air flow at least partially towards other portions within a vehicle, the system comprising:
at least one suction port provided at a location on the peripheral surface of the front windshield;
at least one suction blower communicating with the suction port and adapted to suck air discharged from a defrost nozzle through the suction port, and route the sucked air towards a rear portion of the vehicle;
a conduit in fluid communication with the suction port and the suction blower, and in communication with a plurality of channels communicating with a set of discharge ports, the conduit being configured to route the sucked air to the discharge ports, through the channels, wherein:
at least one of the discharge ports is located adjacent to at least one of the driver side glass, the side occupant glass and the rear windshield of the vehicle.

2. A system of claim 1, further comprising at least one suction port mounted in the space between the vehicle's roof and the front windshield's headliner.

3. A system of claim 1, further comprising two suction ports mounted substantially proximal to the bottom ends of the A-pillars of the vehicle, and adapted to suck air from the bottom portion of the front windshield.

4. A system of claim 1, further comprising two suctions ports mounted substantially proximal to the top ends of the A-pillars of the vehicle, and adapted to suck air from the top portion of the front windshield.

5. A system of claim 1, further comprising at least one suction port mounted at the center of the space between the roof and the front windshield headliner.

6. A system of claim 1, further comprising two suction blowers, one each mounted over the top of the front side glass and the rear side glass, on the left side and the right side of the vehicle.

7. A system of claim 1, wherein the conduit extends substantially along the top of the front and the rear side glass.

8. The system of claim 7, wherein the conduit bifurcates into a first channel communicating with a first discharge port disposed over the front side glass, and a second channel communicating with a second discharge port disposed over the rear side glass, the discharge ports being adapted to discharge the sucked air over the front side glass and the rear side glass, respectively.

9. A system of claim 8, wherein the first and the second discharge ports are positioned in abutment to the B-pillar of the vehicle, on either side thereof.

10. The system of claim 7, further comprising two conduits, one each extending along the left side and the right side of the vehicle.

11. A system of claim 1, further comprising a heating device positioned within the conduit, and adapted to raise the temperature of the sucked air prior to its discharge through the discharge ports.

12. A system of claim 1, wherein the conduit extends towards the rear windshield and communicates with a discharge port positioned proximal to the rear windshield.

13. A system of claim 1, and adapted to evacuate the vehicle's interior section.

14. A system for controlling defrost airflow pattern over the front windshield, and for directing the defrost airflow at least partially towards other portions within a vehicle, the system comprising:
at least one suction port provided at a location either proximal to, or over, a peripheral surface of the front windshield;
at least one suction blower in fluid communication with the suction port and mounted over a top portion of the vehicle, proximal to one of the vehicle's A-pillar or B-pillar, and adapted to suck air discharged from a defrost nozzle of the front windshield, through the suction port, and route the sucked air towards a rear portion of the vehicle;
a conduit in fluid communication with the suction port and the suction blower, and extending between the top portions of the A-pillar and the B-pillar, and further beyond the B-pillar, towards the rear windshield, the conduit in communication with a plurality of channels that communicate with a set of discharge ports, the conduit being configured to route the sucked air to the discharge ports, through the channels, wherein:
at least one of the discharge ports is located adjacent to at least one of the front side glass, the rear side glass and the rear windshield of the vehicle.

15. A system of claim 14, further comprising at least one suction port mounted in the space between the vehicle's roof and the front windshield's headliner.

16. A system of claim 14, further comprising two suction ports mounted substantially proximal to the bottom ends of the A-pillars of the vehicle, and adapted to suck air from the bottom portion of the front windshield, and two suction ports mounted substantially proximal to the top ends of the A-pillars of the vehicle, and adapted to suck air from the top portions of the front windshield.

17. A system of claim 14, further comprising two suction blowers, one each mounted over the top of the front side glass or the rear side glass, on the left side and the right side of the vehicle.

18. The system of claim 14, wherein the conduit communicates with a first discharge port disposed over the front side glass, a second discharge port disposed over the rear side glass, and a third discharge port disposed over the rear windshield, the discharge ports being adapted to discharge the sucked air over the front side glass, the rear side glass, and the rear windshield, respectively.

19. A system of claim 18, wherein the first and the second discharge ports are positioned in abutment with the B-pillar of the vehicle, on either side thereof.

20. A system of claim 18, further comprising two conduits, one each extending along the left side and the right side of the vehicle.
